(19) United States
(12) Patent Application Publication
(10) Pub. No.: US 2020/0197968 A1
(43) Pub. Date: Jun. 25, 2020

(54) Non-Metallic Product Tank For An Agricultural Machine

(71) Applicant: CNH Industrial America LLC, New Holland, PA (US)

(72) Inventors: Blaine Schwalbe, Valders, WI (US); Ross P. Christiansen, Kiel, WI (US)

(21) Appl. No.: 16/227,262

(22) Filed: Dec. 20, 2018

(51) Int. Cl. B05B 13/00

(52) U.S. Cl. CPC B05B 13/00; A01C 23/008

(57) ABSTRACT

The present invention provides an agricultural product delivery system in which a support structure or skid well is configured to rigidly support a primary product storage tank that is manufactured from a non-metallic material such as polyethylene or plastic. The product storage tank can have a capacity of at least 500 gallons, and preferably 1000 gallons, and the support structure can include multiple support ribs spaced along sides of the tank for providing rigid support for the tank and preventing deformation when filled with liquid. In addition, the product storage tank can include one or more contours or cavities for accommodating smaller chemical injection tanks positioned therein. Such chemical injection tanks can also be rigidly supported by the support structure. A spray system can mix liquid from the product storage tank and chemical from a chemical injection tank for spraying a field.

### FIELD OF THE INVENTION

The invention relates generally to agricultural product application equipment such as self-propelled sprayers and, in particular, to an agricultural product delivery system in which a support structure mounted to the chassis frame is configured to rigidly support a primary product storage tank for a spray system in which the tank has a capacity of at least 500 gallons and in which the tank utilizes a non-metallic material.

### BACKGROUND OF THE INVENTION

Agricultural machines such as high-clearance sprayers are getting larger and more complex. Such sprayers typically include a product tank for storing a volume of product for delivery onto an agricultural field and a product delivery pump to convey product from the product tank through plumbing components for release out of spray nozzles that are spaced from each other along the width of a boom. The product tank utilizes a metallic material, typically stainless steel, for rigidly supporting the significant weight of liquid stored therein, oftentimes having a volume exceeding 1000 gallons. However, providing such large tanks in stainless steel can be costly. A need therefore exists for an increasingly cost-effective way to conduct spraying operations in the field while still accommodating the same weight and volume requirements as before.

### SUMMARY OF THE INVENTION

The present invention provides an agricultural product delivery system in which a support structure or skid well is configured to rigidly support a primary product storage tank that is manufactured from a non-metallic material such as polyethylene or plastic. The product storage tank can have a capacity of at least 500 gallons, and preferably 1000 gallons, and the support structure can include multiple support ribs spaced along sides of the tank for providing rigid support for the tank and preventing deformation when filled with liquid. In addition, the product storage tank can include one or more contours or cavities for accommodating smaller chemical injection tanks positioned therein. Such chemical injection tanks can also be rigidly supported by the support structure. A spray system can mix liquid from the product storage tank and chemical from a chemical injection tank for spraying a field.

In one aspect, a “poly” product tank is integrated onto an agricultural machine along with two injection tanks. The poly product tank can be used to reduce the cost of the machine while also providing the ability to inject chemical using a chemical injection system. The main product tank can remain cleaner while just carrying water or a small variant of mixtures. The poly product tank can sit on a skid and can supply a product pump with a carrier liquid. This can be similar in function to stainless steel tanks, but cost may be reduced due to material selection. The tank combination can be set up to include two optional 50-gallon injection tanks. The poly product tank is advantageously shaped to incorporate and allow space for such injection tanks.

Specifically then, one aspect of the present invention can provide an agricultural product delivery system, including: multiple wheels supporting a chassis having a chassis frame; a product storage tank for storing a liquid; a support structure mounted to the chassis frame, the support structure being configured to rigidly support the product storage tank; and a spray system configured to deliver liquid from the product storage tank onto an agricultural field, in which the product storage tank has a capacity of at least 500 gallons, and in which the product storage tank utilizes a non-metallic material for holding the liquid.

Another aspect of the present invention can provide a self-propelled agricultural sprayer, including: multiple wheels supporting a chassis having a chassis frame; a product storage tank for storing liquid; an injection tank for storing a chemical concentrated liquid; a support structure mounted to the chassis frame, the support structure being configured to rigidly support the product storage tank and the injection tank; and a spray system configured to mix liquid from the product storage tank and chemical concentrated liquid from the injection tank for delivery onto an agricultural field, the spray system comprising: a spray boom supported by the chassis and including multiple spray nozzles; and a pump arranged between the spray boom and product storage tank, in which the product storage tank has a capacity of at least 500 gallons, in which the injection tank is smaller than the product storage tank, and in which the product storage tank and the injection tank each utilize a non-metallic material for holding liquid.

Other aspects, objects, features, and advantages of the invention will become apparent to those skilled in the art from the following detailed description and accompanying drawings. It should be understood, however, that the detailed description and specific examples, while indicating preferred embodiments of the present invention, are given by way of illustration and not of limitation. Many changes and modifications may be made within the scope of the present invention without departing from the spirit thereof, and the invention includes all such modifications.

### BRIEF DESCRIPTION OF THE DRAWINGS

Preferred exemplary embodiments of the invention are illustrated in the accompanying drawings in which like reference numerals represent like parts throughout.

FIG. 1 is an isometric view of an agricultural machine in accordance with an aspect of the invention;

FIG. 2 is an isometric view of an agricultural product delivery system of the agricultural machine of FIG. 1 which includes a support structure configured to rigidly support a product storage tank in accordance with an aspect of the invention;

FIG. 3 is an isometric view of an agricultural product delivery system illustrating the support structure mounting to a chassis frame of the agricultural machine of FIG. 1 in accordance with an aspect of the invention;

FIG. 4 is an exploded view of the agricultural product delivery system of FIG. 2; and

FIG. 5 is an isometric view of the support structure of FIG. 2.

### DETAILED DESCRIPTION OF THE PREFERRED EMBODIMENTS

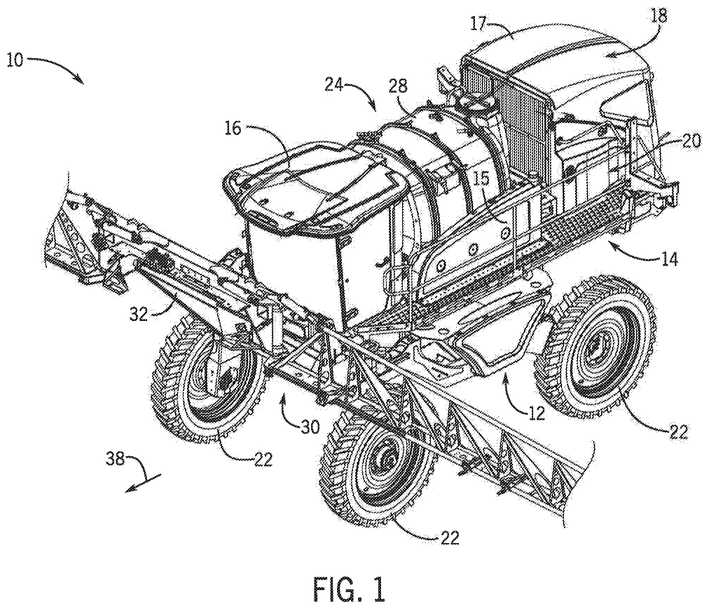

Referring now to the drawings and specifically to FIG. 1, aspects of the invention are shown for use with an agricultural machine which could be an agricultural sprayer. The agricultural sprayer is shown here as a self-propelled agricultural sprayer vehicle or self-propelled sprayer 10. Although sprayer 10 is shown as a front-mounted boom self-propelled sprayer, it is understood that self-propelled versions of sprayer 10 can have either front-mounted or rear-mounted booms, such as those available from CNH Industrial, including the Miller Nitro and Condor Series sprayers and New Holland Guardian Series sprayers.

Still referring to FIG. 1, sprayer 10 includes a chassis 12 having a chassis frame 14 that supports various assemblies, systems, and components. These various assemblies, systems, and components can include an operator cab 16, a spray system 24, and fuel tanks 19, an engine compartment 17 housing an engine 18 and a hydraulic system 20, among other things. The hydraulic system 20 receives power from the engine 18 and includes at least one hydraulic pump which can be in a hydrostat arrangement for providing hydraulic pressure for operating hydraulic components within the hydraulic system 20. For sprayers with hydrostatic drives, hydraulic motors are operably connected to the hydraulic pump(s) for rotating the wheels 22 supporting the chassis 12. In mechanical drive applications, a mechanical transmission receives power from the engine 18 and delivers power for rotating the wheels 22 by way of power-transmitting driveline components such as drive shafts, differentials, and other gear sets in portal, drop boxes, or other housings. The spray system 24 can include storage containers such as a rinse tank for storing water or a rinsing solution and a primary product storage tank 28 for storing a volume of liquid product for delivery onto an agricultural field with sprayer 10. A product delivery pump can convey product from the product storage tank 28 through plumbing components such as interconnected pieces of tubing and through a boom tubing system for release out of spray nozzles that are spaced from each other along the width of a boom 30 during spraying operations of sprayer 10. Groups or banks of multiple adjacent spray nozzles can define multiple spray sections of the spray system. Spray sections defined along boom 30 can selectively deliver product for release onto an agricultural field at locations corresponding to positions of activated spray sections. Boom 30 is connected to chassis 12 with lift arm assembly 32 that is configured to move the boom 30 up and down for adjusting the height of application of the product.

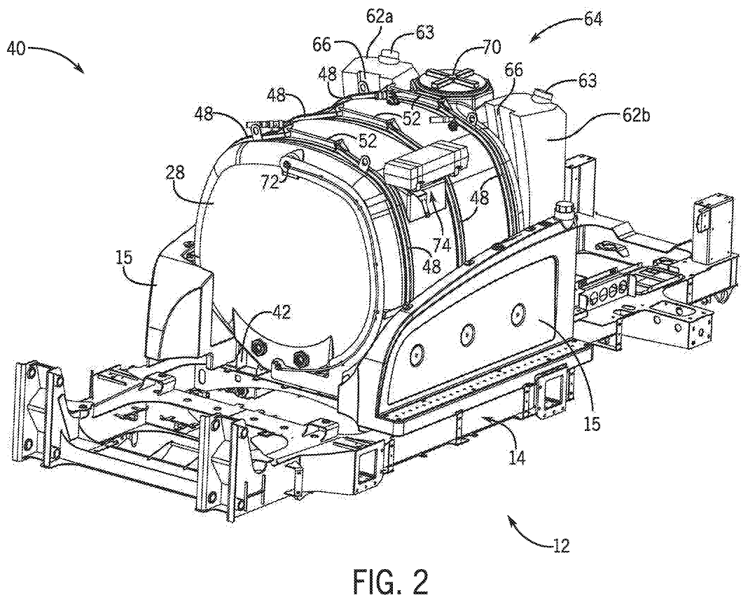

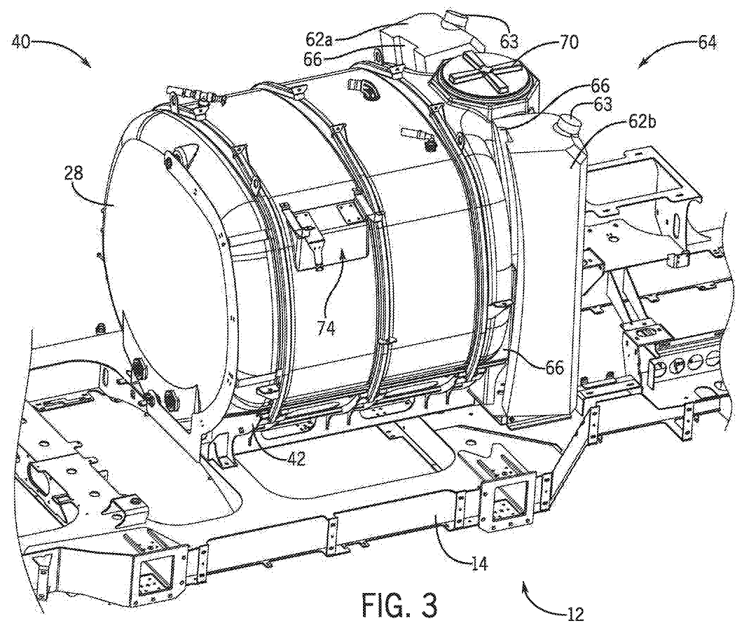

With additional reference to FIGS. 2 and 3, isometric views of an agricultural product delivery system 40 for the sprayer 10 are provided in accordance with an aspect of the invention. The agricultural product delivery system 40 includes a metallic support structure 42 or “skid well” mounted to the chassis frame 14 (see FIG. 3). The support structure 42 is configured to rigidly support the product storage tank 28 so as to prevent movement with respect to the chassis frame 14 and to prevent deformation of the product storage tank 28 when filled with liquid. The product storage tank 28 can have a capacity of at least 500 gallons, and preferably 1000 gallons. As a result, the support structure 42 is configured to rigidly support a significant weight of liquid stored in the product storage tank 28.

For achieving a cost-effective way to conduct spraying operations in the field, the product storage tank 28 is manufactured from a non-metallic material, such as polyethylene or plastic, for holding the liquid. Notwithstanding this construction, with the support structure 42 providing rigid support, the system 40 can accommodate the weight and volume requirements of the product storage tank 28. In operation, the spray system 24 can deliver liquid from the product storage tank 28, spray nozzles that are spaced from each other along the width of boom 30, for delivery onto an agricultural field.

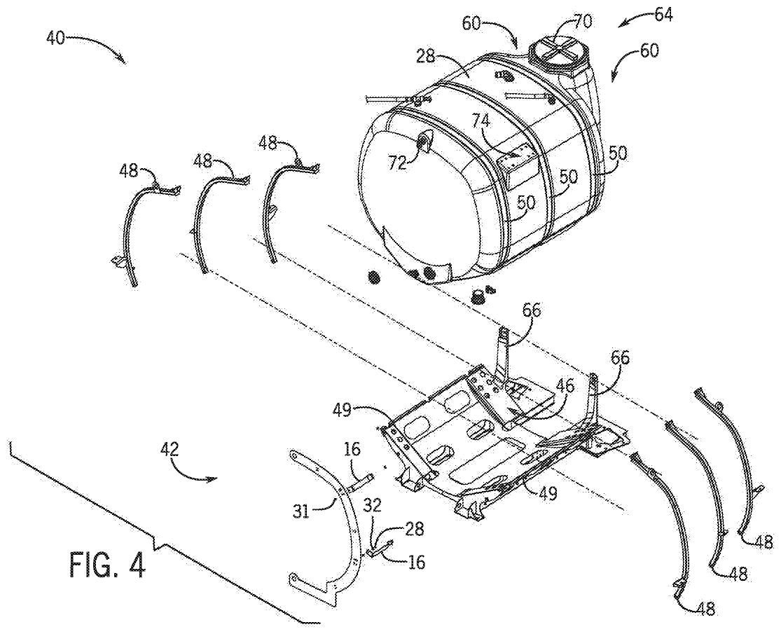

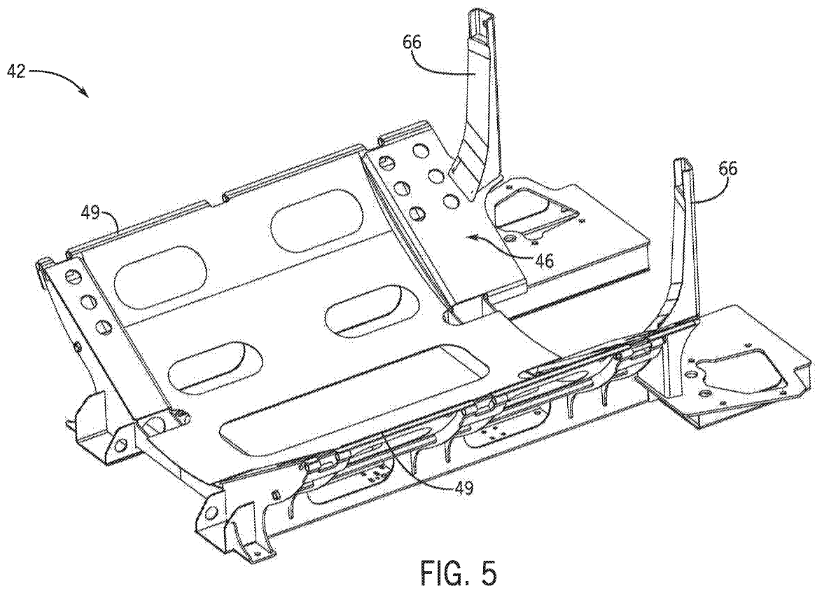

With additional reference to FIG. 4, an exploded view of the agricultural product delivery system 40 is provided in accordance with an aspect of the invention. The product storage tank 28 may have a rounded cross-section from left to right and may be cylindrical in shape from front to back (oriented with respect to a forward travel direction of the sprayer 10 as shown in FIG. 1). As may best be seen FIG. 5, a detailed view of the support structure 42, the support structure 42 can include a concave interior 46 defining a contour or cavity configured to receive the product storage tank 28 along its length. Fasteners can be used to join the product storage tank 28 to the support structure 42 along the concave interior 46. In addition, the support structure 42 can include multiple support ribs 48 spaced laterally along opposing sides of the product storage tank 28. Such support ribs 48, received by upper edges 49 on opposing sides of the support structure 42, can support the rounded cross section of the product storage tank 28 with greater rigidity to prevent deformation when filled with liquid. Multiple channels 50 defined radially along the surface of the product storage tank 28 can receive respective support ribs 48 for added rigidity. In addition, cross locks 52 can connect the support ribs 48 on opposing sides, above the product storage tank 28, to enclose the product storage tank 28 by a frame defined by the support structure 42.

In addition, the product storage tank can include one or more contours or cavities 60 for accommodating one or more smaller chemical injection tanks 62 for storing a chemical concentrated liquid positioned therein. The injection tanks 62 can be filled with the chemical concentrated liquid through top mounted filling ports 63. The spray system 24 can mix liquid from the product storage tank 28 and chemical from an injection tank 62 for spraying a field. The injection tanks 62 are typically smaller than the product storage tank 28, having a capacity of less than 100 gallons, and preferably 50 gallons. The injection tanks 62 can also be manufactured from a non-metallic material, such as polyethylene or plastic, for holding the chemical concentrated liquid.

The injection tanks 62 can be rigidly supported by the same support structure 42. In one aspect, first and second injection tanks 62a and 62b, respectively, can be rigidly supported by the support structure 42 on opposing sides of the product storage tank 28. Moreover, the first and second injection tanks 62a and 62b, respectively, can be rigidly supported on opposing sides of a rear side 64 of the product storage tank 28. The support structure 42 can include rigid, metallic vertical extensions 66 (see FIGS. 4 and 5) configured to engage channels 68 (see FIG. 2) of the first and second injection tanks 62a and 62b, respectively, for retention thereof. The vertical extensions 66 can align with the cavities 60, so that the injection tanks 62 are positioned in the cavities 60, adjacent to the product storage tank 28, and mounted to the support structure 42. Fasteners can be used to join the injection tanks 62 to the vertical extensions 66.

Accordingly, the product storage tank 28 and the support structure 42 can provide a cost-effective way to conduct spraying operations in the field, supporting in excess of 1000 gallons of liquid, with rigid support and without deformation. The product storage tank 28 can include a tank lid 70 for accessing an interior volume of the tank, such as for filling the tank with liquid. The product storage tank 28 can also include an access port and gauge 72, such as a sight gauge, for measuring an amount of liquid in the interior volume. The product storage tank 28 can also include a hand rinsing station 74 for allowing an operator to access the liquid, typically water, such as for hand washing.

Although the best mode contemplated by the inventors of carrying out the present invention is disclosed above, practice of the above invention is not limited thereto. It will be manifest that various additions, modifications and rearrangements of the features of the present invention may be made without deviating from the spirit and the scope of the underlying inventive concept.

We claim:

1. An agricultural product delivery system, comprising:
a plurality of wheels supporting a chassis having a chassis frame;
a product storage tank for storing a liquid;
a support structure mounted to the chassis frame, the support structure being configured to rigidly support the product storage tank; and
a spray system configured to deliver liquid from the product storage tank onto an agricultural field,
wherein the product storage tank has a capacity of at least 500 gallons, and
wherein the product storage tank utilizes a non-metallic material for holding the liquid.

2. The system of claim 1, wherein the support structure comprises a plurality of support ribs spaced laterally along opposing sides of the product storage tank.

3. The system of claim 2, wherein the product storage tank comprises a plurality of channels for receiving the support ribs.

4. The system of claim 1, wherein the non-metallic material is plastic.

5. The system of claim 1, wherein the non-metallic material is polyethylene.

6. The system of claim 1, further comprising an injection tank for storing a chemical concentrated liquid, wherein the injection tank is smaller than the product storage tank, and wherein the support structure is further configured to rigidly support the injection tank.

7. The system of claim 6, wherein the spray system is configured to mix liquid from the product storage tank and chemical concentrated liquid from the injection tank for delivery onto the agricultural field.

8. The system of claim 6, wherein the product storage tank has a capacity of at least 1000 gallons, and wherein the injection tank has a capacity of less than 100 gallons.

9. The system of claim 6, wherein the injection tank is a first injection tank, and further comprising a second injection tank, wherein the first and second injection tanks are rigidly supported by the support structure on opposing sides of the product storage tank.

10. The system of claim 9, wherein the support structure comprises vertical extensions configured to engage channels of the first and second injection tanks for retention thereof.

11. The system of claim 9, wherein the first and second injection tanks utilize a non-metallic material for holding the chemical concentrated liquid.

12. The system of claim 9, wherein the first and second injection tanks are rigidly supported by the support structure on opposing sides of a rear side of the product storage tank.

13. The system of claim 1, wherein the product storage tank comprises:
a tank lid for accessing an interior volume; and
a gauge for measuring an amount of liquid in the interior volume.

14. The system of claim 13, wherein the product storage tank further comprises a hand rinsing station.

15. A self-propelled agricultural sprayer, comprising:
a plurality of wheels supporting a chassis having a chassis frame;
a product storage tank for storing liquid;
an injection tank for storing a chemical concentrated liquid;
a support structure mounted to the chassis frame, the support structure being configured to rigidly support the product storage tank and the injection tank; and
a spray system configured to mix liquid from the product storage tank and chemical concentrated liquid from the injection tank for delivery onto an agricultural field, the spray system comprising:
a spray boom supported by the chassis and including multiple spray nozzles; and
a pump arranged between the spray boom and product storage tank,
wherein the product storage tank has a capacity of at least 500 gallons,
wherein the injection tank is smaller than the product storage tank, and
wherein the product storage tank and the injection tank each utilize a non-metallic material for holding liquid.

16. The sprayer of claim 15, wherein the support structure comprises a plurality of support ribs spaced laterally along opposing sides of the product storage tank.

17. The sprayer of claim 16, wherein the product storage tank comprises a plurality of channels for receiving the support ribs.

18. The sprayer of claim 15, wherein the non-metallic material is plastic.

19. The sprayer of claim 15, wherein the product storage tank has a capacity of at least 1000 gallons, and wherein the injection tank has a capacity of less than 100 gallons.

20. The sprayer of claim 15, wherein the injection tank is a first injection tank, and further comprising a second injection tank, wherein the first and second injection tanks are rigidly supported by the support structure on opposing sides of the product storage tank.
